(19) United States
(12) Patent Application Publication
(10) Pub. No.: US 2017/0040606 A1
(43) Pub. Date: Feb. 9, 2017

(54) POSITIVE ELECTRODE ACTIVE MATERIAL FOR NONAQUEOUS ELECTROLYTE SECONDARY BATTERIES AND NONAQUEOUS ELECTROLYTE SECONDARY BATTERY INCLUDING THE SAME

(71) Applicant: Sanyo Electric Co., Ltd.

(72) Inventors: Daisuke Nishide, Hyogo (JP); Takeshi Ogasawara, Hyogo (JP)

(73) Assignees: Sanyo Electric Co., Ltd., Daito-shi, Osaka (JP); Sanyo Electric Co., Ltd., Daito-shi, Osaka (JP)

(21) Appl. No.: 15/106,763

(22) PCT Filed: Dec. 18, 2014
(86) PCT No.: PCT/JP2014/006314

§ 371 Date: Jun. 20, 2016

(30) Foreign Application Priority Data
Dec. 27, 2013 (JP) 2013-271274

(51) Int. Cl. H01M 4/48; H01M 4/58; H01M 10/0525; H01M 4/36

(52) U.S. Cl. CPC H01M 4/483; H01M 4/366; H01M 4/58; H01M 10/0525; H01M 2004/028

(57) ABSTRACT

An object of the present invention is to provide a nonaqueous electrolyte secondary battery having a high post-cycle normal-temperature output retention. A positive electrode active material for nonaqueous electrolyte secondary batteries includes a lithium transition metal oxide including at least one element selected from the group consisting of elements belonging to Group 5 of the periodic table. The lithium transition metal oxide includes a rare earth compound deposited on the surface thereof. Using tantalum as an element belonging to Group 5 of the periodic table is particularly preferable because it stabilizes the internal structure of particles in a suitable manner.

### TECHNICAL FIELD

The present invention relates to a positive electrode active material for nonaqueous electrolyte secondary batteries and a nonaqueous electrolyte secondary battery including the positive electrode active material.

### BACKGROUND ART

There has been a rapid progress in reductions in the size and weight of mobile information terminals such as mobile telephones, notebook computers, and smart phones. Accordingly, there has been a demand for a further increase in the capacities of secondary batteries, which are used as a power source for driving the mobile information terminals. In particular, nonaqueous electrolyte secondary batteries, which are charged and discharged due to the migration of lithium ions between the positive and negative electrodes, have been widely used as a power source for driving the above mobile information terminals because they have a high energy density and a high capacity.

Attention has been focused on nonaqueous electrolyte secondary batteries as a power source for driving electric tools, electric vehicles (EV)/hybrid electric vehicles (HEV, PHEV), and the like. A further increase in the use of nonaqueous electrolyte secondary batteries has been anticipated. Such driving power sources are required to have a high capacity with which the driving power sources can be used for a prolonged period of time and improved output characteristics that occur when the driving power sources are charged and discharged with a high current in a relatively short period of time. In particular, power sources used for driving electric tools, EVs, HEVs, PHEVs, and the like are required to have a high capacity, a long service life, a high output, and a high level of safety while maintaining good output characteristics that occur-when the driving power sources are charged and discharged at a high current.

For example, Patent Literature 1 suggests that using a positive electrode active material that includes a composite oxide containing lithium and nickel and a compound containing tantalum improves the thermal stability of the positive electrode of a battery that is being charged.

Patent Literature 2 suggests that depositing a rare earth element, on the surfaces of base particles of a positive electrode active material limits the degradation of the charge-conservation characteristics of a battery which may occur due to the decomposition of an electrolyte solution, which takes place at the interface between the positive electrode active material and the electrolyte solution when the charging voltage is increased.

### CITATION LIST

### Patent Literature

PTL 1: Japanese Published Unexamined Patent Application No. 2003-123750

PTL 2: WO2005/008812

### SUMMARY OF INVENTION

### Technical Problem

It was found that it is not possible to produce a battery having a high post-cycle normal-temperature output retention even by using the technique disclosed in Patent Literature 1 or Patent Literature 2.

### Solution to Problem

A positive electrode active material for nonaqueous electrolyte secondary batteries according to an aspect of the present invention includes a lithium transition metal oxide including at least one element selected from the group consisting of elements belonging to Group 5 of the periodic table. The positive electrode active material includes a compound containing a rare earth element which is deposited on the surface of the positive electrode active material.

### Advantageous Effects of Invention

A nonaqueous electrolyte secondary battery according to an aspect of the present invention is a nonaqueous electrolyte secondary battery including the above-described positive electrode active material, the nonaqueous electrolyte secondary battery having a high post-cycle normal-temperature output retention.

### DESCRIPTION OF EMBODIMENTS

A positive electrode active material for nonaqueous electrolyte secondary batteries includes a lithium transition metal oxide including at least one element selected from the group consisting of elements belonging to Group 5 of the periodic table. The positive electrode active material includes a compound containing a rare earth element which is deposited on the surface of the positive electrode active material.

### EXAMPLES

The present invention is described further in detail with reference to Test Examples below. The present invention is not limited by Test Examples below. The present invention may be implemented by making modifications appropriately without changing the scope of the present invention.

### First Test Examples

### Test Example 1

The structure of a three-electrode test cell prepared in Test Example 1 is described.

[Preparation of Positive Electrode Plate]

Lithium carbonate Li₂CO₃, a nickel-cobalt-manganese composite hydroxide represented by [Ni_{0.35}Co_{0.35}Mn_{0.30}] (OH)₂, which was prepared by coprecipitation/and tantalum pentoxide were mixed together using an Ishikawa mortar grinder such that the molar ratio between lithium, the total of the transition metals (nickel, cobalt, and manganese), and tantalum was 1.10:1:0.007.

The resulting mixture was heat-treated in an air atmosphere at 1000° C. for 20 hours and subsequently pulverized to form a lithium-nickel-cobalt-manganese composite oxide containing tantalum, which is represented by Li_{1.06}[Ni_{0.33}Co_{0.33}Mn_{0.28}]O₂. The results of EPMA elemental mapping of cross sections of the resulting particles confirmed that tantalum was present inside the particles.

The results of an XRD analysis of the crystal structure of the lithium-nickel-cobalt-manganese composite oxide confirmed that the volume of the crystal lattice of the lithium-nickel-cobalt-manganese composite oxide containing tantalum was changed from that of a lithium-nickel-cobalt-manganese composite oxide represented by Li_{1.06}[Ni_{0.33}Co_{0.33}Mn_{0.28}]O₂ which did not contain tantalum. This confirms that tantalum was dissolved inside the crystals.

While 1000 g of a powder of the lithium transition metal oxide prepared by the above-described method was stirred, a solution prepared by dissolving 1.7 g of erbium acetate tetrahydrate in 40 mL of pure water was added to the powder in small amounts a plurality of times.

The resulting powder was dried at 120° C. for 2 hours and subsequently heat-treated at 250° C. for 6 hours.

The amount of the erbium oxyhydroxide deposited was 0.07% by mass of the amount of the lithium transition metal oxide in terms of erbium.

The positive electrode active material prepared in the above-described manner was mixed with carbon black used as a positive electrode conductant agent and polyvinylidene fluoride (PVdF) used as a binder such that the mass ratio between the positive electrode active material, the positive electrode conductant agent, and the binder was 92:5:3. The resulting mixture was added to an appropriate amount of N-methyl-2-pyrrolidone used as a disperse medium and subsequently kneaded to form a positive-electrode mixture slurry. The positive-electrode mixture slurry was uniformly applied onto one surface of a positive electrode current collector composed of an aluminium foil. After being dried, the resulting positive electrode current collector was rolled with a roller such that the packing density of a positive electrode mixture layer formed on one surface of the positive electrode current collector was 2.8 g/cm³.

A positive electrode current collector tab was attached to the surface of the positive electrode current collector. Thus, a positive electrode plate including the positive electrode current collector and the positive electrode mixture layer formed on one surface of the positive electrode current collector was prepared.

A three-electrode test cell was prepared using the above-described positive electrode plate as a working electrode and metal lithium plates as a counter electrode and a reference electrode. The nonaqueous electrolyte used was prepared in the following manner. In a mixed solvent containing ethylene carbonate (EC), methyl ethyl carbonate (MEC), and dimethyl carbonate (DMC), which were used as nonaqueous electrolytes, at a volume ratio of 3:3:4, lithium hexafluorophosphate was dissolved such that the concentration of lithium hexafluorophosphate was 1.0 mol/liter. Vinylene carbonate (VC) was further added and dissolved in the resulting solution such that the amount of vinylene carbonate was 1% by mass of the total amount of the electrolyte solution.

Hereinafter, the three-electrode test cell prepared in the above-described manner is referred to as “battery A1”.

### Test Example 2

A battery A2 was prepared as in Test Example A1, except that a lithium-nickel-cobalt-manganese composite oxide prepared by heat-treating a mixture that did not contain tantalum pentoxide was used.

### Test Example 3

A battery A3 was prepared as in Test Example A1, except that the aqueous erbium acetate solution was not used in the preparation of the positive electrode active material and an active material prepared prior to the addition of the aqueous erbium acetate solution was used.

### Test Example 4

A battery A4 was prepared as in Test Example 1, except that a lithium-nickel-cobalt-manganese composite oxide prepared by heat-treating a mixture that did not contain tantalum pentoxide was used and the aqueous erbium acetate solution was not added to the lithium-nickel-cobalt-manganese composite oxide in the preparation of the positive electrode active material.

The batteries A1 to A4 prepared in Test Examples 1 to 4 above were each subjected to the following charge-discharge tests.

Initial Charge-Discharge Test

The batteries A1 to A4 were each charged with a constant current to 4.3 V (vs. Li/Li⁺) at a current density of 0.2 mA/cm² at 25° C. After the potential of the positive electrode had reached 4.3 V (vs. Li/Li⁺), the batteries A1 to A4 were each charged with a constant voltage of 4.3 V until the current density reached 0.04 mA/cm². Subsequently, the batteries A1 to A4 were each discharged with a constant current at a current density of 0.2 mA/cm² until the voltage of the battery reached 2.5 V (vs. Li/Li⁺). After the batteries A1 to A4 had been charged and discharged in the above manner, the initial discharge capacity of each of the batteries A1 to A4 was measured and considered to be the rated discharge capacity of the battery. Rest intervals of 10 minutes were provided between charging and discharging.

Measurement of Initial Normal-Temperature Output Characteristics

The batteries A1 to A4 that had been subjected to the initial charge-discharge test were each charged at a current-density of 0.2 mA/cm² at 25° C. until 50% of the rated capacity of the battery was achieved. Subsequently, the batteries A1 to A4 were each discharged at current densities of 0.08, 0.4, 0.8, 1.2, 1.6, and 2.4 mA/cm² for 10 seconds, and the voltage of the battery was measured. The current density at which the voltage of each of the batteries A1 to A4 reached 2.5 V when the battery was discharged for 10 seconds was determined by plotting the measured voltages of the battery against the current densities.

The product (output density) of the determined current density of each of the batteries A1 to A4 and 2.5 V was considered to be the initial normal-temperature output of the battery. The depth of charge capacity of each of the batteries A1 to A4, which was deviated due to discharging, was returned to the original depth of charge capacity of the battery by charging the battery with a constant current of 0.08 mA/cm².

Cycle Test

The batteries A1 to A4 that had been subjected to the measurement of initial normal-temperature output characteristics were each charged with a constant current at 25° C. at a current density of 1.0 mA/cm² until the potential of the positive electrode reached 4.3 V (vs. Li/Li⁺). After the potential of the positive electrode reached 4.3 V (vs. Li/Li⁺), the batteries A1 to A4 were each charged with a constant voltage of 4.3 V until the current density reached 0.04 mA/cm². Subsequently, the batteries A1 to A4 were each discharged with a constant current at a current density of 2.5 mA/cm² until the voltage of the battery reached 2.5 V (vs. Li/Li⁺). The batteries A1 to A4 were subjected to ten cycles of charge-discharge tests under the above-described charging-discharging conditions. Rest intervals of 10 minutes were provided between charging and discharging.

Measurement of Post-Cycle Normal-Temperature Output-Characteristics

The normal-temperature output of each of the batteries A1 to A4 that, had been subjected to the cycle test was measured as in the measurement of the initial normal-temperature output characteristics in order to determine the post-cycle normal-temperature output of the battery. The post-cycle normal-temperature output of each of the batteries was converted to a relative value with 100 of the initial normal-temperature output of the battery, which was considered to be the post-cycle normal-temperature output retention of the battery. Table 1 summarizes the results.

TABLE 1

| | | Rare earth | Normal-temperature |
|---|---|---|---|
| | Group-5 | compound | output retention after |
| | element | on surface | 10 cycles (%) |
| Test example 1 | Yes (Ta) | Yes (Er) | 98.9 |
| Test example 2 | No | Yes (Er) | 95.9 |
| Test example 3 | Yes (Ta) | No | 91.2 |
| Test example 4 | No | No | 95.5 |

As is clear from the results summarized in Table 1, the battery prepared in Test Example 1, which included lithium-nickel-cobalt-manganese composite oxide particles that contained at least one element selected from the group consisting of elements belonging to Group 5 of the periodic table and included a rare earth compound deposited on the surfaces of the particles, had a higher post-cycle normal-temperature output retention than the batteries prepared in Test Examples 2 to 4.

The battery prepared in Test Example 2, which included lithium-nickel-cobalt-manganese composite oxide particles that did not contain an element belonging to Group 5 of the periodic table but included a rare earth compound deposited on the surfaces of the particles, had a slightly higher post-cycle normal-temperature output retention than the battery prepared in Test Example 4, which did not contain either an element belonging to Group 5 of the periodic table or a rare earth compound, and is considered to be slightly improved.

The battery prepared in Test Example 3, which included lithium-nickel-cobalt-manganese composite oxide particles that contained an element belonging to Group 5 of the periodic table but did not include a rare earth compound deposited on the surfaces of the particles, had a lower post-cycle normal-temperature output retention than the battery prepared in Test Example 4, which did not contain either an element belonging to Group 5 of the periodic table or a rare earth compound.

In contrast, the battery prepared in Test Example 1, which included both element belonging to Group 5 of the periodic table and rare earth compound, had a markedly improved post-cycle normal-temperature output retention compared with that of the battery that included only a rare earth compound deposited on the surfaces of the particles. It is considered that the above-described results were obtained for the following reasons.

In the battery prepared in Test Example 4, which included lithium-nickel-cobalt-manganese composite oxide particles that did not contain either an element belonging to Group 5 of the periodic table or a rare earth compound deposited on the surfaces of the particles, the decomposition reaction of the nonaqueous electrolyte solution occurred on the surfaces of the active material particles when the battery was charged and discharged. This caused the surface layers of the active material particles to be easily degraded and promoted the degradation of the internal structure of the particles. As a result, the post-cycle normal-temperature output retention of the battery was reduced.

In the battery prepared in Test Example 3, which included lithium-nickel-cobalt-manganese composite oxide particles that contained an element belonging to Group 5 of the periodic table, that is, tantalum, but did not include a rare earth compound deposited on the surfaces of the particles, the internal structure of the particles was stabilized due to the effect of tantalum. However, under the great impacts of the degradation of the surface layers of the active material particles which was caused due to the decomposition reaction of the nonaqueous electrolyte solution which occurred on the surfaces of the active material particles and the formation of resistive layers due to the elution of tantalum from the surface layers, the increase in the output retention of the battery which was caused due to the stabilization of the inner structure was canceled out. As a result, the post-cycle normal-temperature output retention of the battery was reduced.

In the battery prepared in Test Example 2, which included lithium-nickel-cobalt-manganese composite oxide particles that did not contain an element belonging to Group 5 of the periodic table, that is, tantalum, but included a rare earth compound deposited on the surfaces of the particles, the decomposition reaction of the nonaqueous electrolyte solution which occurred on the surfaces of the active material particles was limited due to the presence of the rare earth compound. However, a current was concentrated at portions on which the rare earth compound, that served as a resistive component, was absent and the structure of the portions was significantly degraded. As a result, it was not possible to limit a reduction in the post-cycle normal-temperature output retention of the battery to a sufficient degree.

In contrast, in the battery prepared in Test Example 1, which included lithium-nickel-cobalt-manganese composite oxide particles that contained an element belonging to Group 5 of the periodic table and included a rare earth compound deposited on the surfaces of the particles, the rare earth compound deposited on the surfaces of the lithium-nickel-cobalt-manganese composite oxide particles limited not only the decomposition reaction of the electrolyte solution but also the elution of the element belonging to Group 5 of the periodic table, that is, tantalum, which was included in the surface layers. As a result, both degradation of the surface layers and degradation of internal structure of the particles were limited. Thus, the post-cycle normal-temperature output retention of the battery was markedly increased.

### Second Test Examples

### Test Example 5

A battery A5 was prepared as in Test Example 1, except that samarium acetate tetrahydrate was used instead of erbium acetate tetrahydrate as a rare earth compound in the preparation of the positive electrode active material.

### Test Example 6

A battery A6 was prepared as in Test Example 2, except that samarium acetate tetrahydrate was used instead of erbium acetate tetrahydrate as a rare earth compound in the preparation of the positive electrode active material.

### Test Example 7

A battery A7 was prepared as in Test Example 1, except that lanthanum acetate sesquihydrate was used instead of erbium acetate tetrahydrate as a rare earth compound in the preparation of the positive electrode active material.

### Test Example 8

A battery A8 was prepared as in Test Example 2, except that lanthanum acetate sesquihydrate was used instead of erbium acetate tetrahydrate as a rare earth compound in the preparation of the positive electrode active material.

### Test Example 9

A battery A9 was prepared as in Test Example 1, except that neodymium acetate monohydrate was used instead of erbium acetate tetrahydrate as a rare earth compound in the preparation of the positive electrode active material.

### Test Example 10

A battery A10 was prepared as in Test Example 2, except that neodymium acetate monohydrate was used instead of erbium acetate tetrahydrate as a rare earth compound in the preparation of the positive electrode active material.

The batteries prepared in Test Examples 5 to 10 in the above-described manner were each subjected to a charge-discharge test as in Test Examples 1 to 4 in order to determine the post-cycle normal-temperature output retention of the battery. Table 2 summarizes the results.

TABLE 2

| | | Rare earth | Normal-temperature |
|---|---|---|---|
| | Group-5 | compound | output retention after |
| | element | on surface | 10 cycles (%) |
| Test Example 1 | Yes (Ta) | Yes (Er) | 98.9 |
| Test Example 2 | No | Yes (Er) | 95.9 |
| Test Example 3 | Yes (Ta) | No | 91.2 |
| Test Example 4 | No | No | 95.5 |
| Test Example 5 | Yes (Ta) | Yes (Sm) | 98.4 |
| Test Example 6 | No | Yes (Sm) | 95.7 |
| Test Example 7 | Yes (Ta) | Yes (La) | 98.0 |
| Test Example 8 | No | Yes (La) | 95.6 |
| Test Example 9 | Yes (Ta) | Yes (Nd) | 97.8 |
| Test Example 10 | No | Yes (Nd) | 95.6 |

As is clear from the results summarized in Table 2, it was confirmed that the batteries prepared in Test Examples 5, 7, and 9, which included lithium-nickel-cobalt-manganese composite oxide particles that contained at least one element selected from the group consisting of elements belonging to Group 5 of the periodic table and included a rare earth compound, deposited on the surfaces of the particles, had a higher post-cycle normal-temperature output retention than the batteries prepared in Test Examples 2 to 4 and that the advantageous effect was achieved regardless of the type of the rare earth element used.

### Third Test Examples

### Test Example 11

The structure of a cylindrical nonaqueous electrolyte secondary battery prepared in Test Example 11 is described below.

### [Preparation of Positive Electrode Plate]

A positive electrode active material prepared as in Test Example 1 was mixed with carbon black used as a positive electrode conductant agent and polyvinylidene fluoride (PVdF) used as a binder such that the mass ratio between the positive electrode active material, the positive electrode conductant agent, and the binder was 92:5:3. The resulting mixture was added to an appropriate amount of N-methyl-2-pyrrolidone used as a disperse medium and subsequently kneaded to form a positive-electrode mixture slurry. The positive-electrode mixture slurry was uniformly applied to both surfaces of a positive electrode current collector composed of an aluminium foil. After being dried, the resulting positive electrode current collector was roiled with a roller. Thus, a positive electrode plate including an aluminium foil and positive electrode mixture layers formed on both surfaces of the aluminium foil was prepared.

### [Preparation of Negative Electrode Plate]

A graphite powder, carboxymethyl cellulose (CMC), and styrene-butadiene rubber (SBR) were mixed such that the weight ratio between the graphite powder, CMC, and SBR was 98:1:1. Water was added to the resulting mixture. The mixture was stirred with a mixer (T.K. HIVIS MIX produced by PRIMIX Corporation) to form a negative electrode mixture slurry. The negative electrode mixture slurry was applied to a copper foil used as a negative electrode current collector. After the resulting coating film had been dried, the resulting copper foil was rolled with a roller. This, a negative electrode including a copper foil and negative electrode mixture layers formed on both surfaces of the copper foil was prepared.

### [Preparation of Nonaqueous Electrolyte Solution]

In a mixed solvent containing ethylene carbonate (EC), methyl ethyl carbonate (MEC), and dimethyl carbonate (DMC), which were used as nonaqueous electrolytes, at a volume ratio of 3:3:4, lithium hexafluorophosphate was dissolved such that the concentration of lithium hexafluorophosphate was 1.0 mol/liter. Vinylene carbonate (VC) was further-added and dissolved in the resulting solution such that the amount of vinylene carbonate was 1% by mass of the total amount of the electrolyte solution.

### [Preparation of Cylindrical Nonaqueous Electrolyte Secondary Battery]

An aluminium lead was attached to the positive electrode plate, and a nickel lead was attached to the negative electrode plate. A microporous membrane composed of polyethylene was used as a separator. The positive electrode plate, the separator, and the negative electrode plate were stacked on top of one another such that the separator was interposed between the positive and negative electrode plates, and the resulting multilayer body was wound in a scroll-like manner to form a wound electrode body. The electrode body was put in a cylindrical battery case main body having a bottom. After the nonaqueous electrolyte solution had been charged into the battery case main body, the opening of the battery case main body was sealed with a gasket and a sealing material. Thus, a cylindrical nonaqueous electrolyte secondary battery (hereinafter, referred to as “battery A11”) was prepared.

### Test Example 12

A battery A12 was prepared as in Test Example A11, except that a lithium-nickel-cobalt-manganese composite oxide containing niobium prepared by heat-treating a mixture containing niobium oxide instead of tantalum pentoxide was used.

### Test Example 13

A battery A13 was prepared as in Test Example A11, except that a lithium-nickel-cobalt-manganese composite oxide containing molybdenum prepared by heat-treating a mixture containing molybdenum oxide instead of tantalum pentoxide was used.

### Test Example 14

A battery A14 was prepared as in Test Example A11, except that a lithium-nickel-cobalt-manganese composite oxide prepared by heat-treating a mixture that did not contain tantalum pentoxide was used.

The batteries A11 to A14 prepared in Test Examples 11 to 14 were subjected to the charge-discharge tests described below.

Initial Charge-Discharge Test

The batteries A11 to A14 were charged with a constant current of 800 mA to 4.2 V at 25° C. After the potential of the battery had reached 4.2 V, the batteries were each charged with a constant voltage of 4.2 V until the current reached 40 mA. Subsequently, the batteries A11 to A14 were each discharged with a constant current of 800 mA until the voltage of the battery reached 2.5 V. After the batteries A11 to A14 had been charged and discharged in the above manner, the initial discharge capacity of each of the batteries A11 to A14 was measured and considered to be the rated discharge capacity of the battery. Rest intervals of 10 minutes were provided between charging and discharging.

Measurement of Initial Normal-Temperature Output Characteristics

The batteries A11 to A14 that had been subjected to the initial charge-discharge test were each charged at a current of 800 mA at 25° C. until 50% of the rated capacity was achieved. Subsequently, the maximum current at which the battery was able to be discharged within 10 seconds when the discharge-end voltage was set to 2.5 V was measured. The output of each of the battery A11 to A14 at a depth of charge capacity (SOC) of 50% was determined by the following formula.

Output (SOC 50%)=Maximum Current×Discharge End Voltage (2.5 V)

Cycle Test

The batteries A11 to A14 that had been subjected to the measurement of initial normal-temperature output characteristics were each charged with a constant current of 800 mA at 25° C. until the potential of the battery reached 4.2 V. Subsequently, the batteries A11 to A14 were each discharged with a constant current of 800 mA until the voltage of the battery reached 2.5 V. The batteries A11 to A14 were subjected to 100 cycles of charge-discharge tests under the above charging-discharging conditions. Rest intervals of 10 minutes were provided between charging and discharging.

Measurement of Post-Cycle Normal-Temperature Output Characteristics

The normal-temperature output of each of the batteries A11 to A14 that had been subjected to the cycle test was measured as in the measurement of the initial normal-temperature output characteristics in order to determine the post-cycle normal-temperature output of the battery. The post-cycle normal-temperature output of each of the batteries A11 to A14 was converted to a relative value with 100 of the initial normal-temperature output of the battery, which was considered to be the post-cycle normal-temperature output retention of the battery. Table 3 summarizes the results.

TABLE 3

| | | | Normal- |
|---|---|---|---|
| | | | temperature |
| | | Rare earth | output |
| | | compound | retention after |
| | Element | on surface | 100 cycles (%) |
| Test example 11 | Yes (Ta: Group 5) | Yes (Er) | 95.9 |
| Test example 12 | Yes (Nb: Group 5) | Yes (Er) | 92.2 |
| Test example 13 | Yes (Mo: Group 6) | Yes (Er) | 82.2 |
| Test example 14 | No | Yes (Er) | 88.7 |

As is clear from the results summarized in Table 3, the batteries prepared in Test Examples 11 and 12, which included lithium-nickel-cobalt-manganese composite oxide particles that contained at least one element selected from the group consisting of elements belonging to Group 5 of the periodic table and included a rare earth compound deposited on the surfaces of the particles, had a higher normal-temperature output retention after 100 cycles than the batteries prepared in Test Examples 13 and 14. This confirms that the advantageous effect was achieved regardless of the type of the Group-5 element used.

According to an embodiment of the present invention, the lithium-nickel-cobalt-manganese composite oxide preferably includes at least one element selected from the group consisting of elements belonging to Group 5 of the periodic table. This is because elements belonging to Group 5 of the periodic table readily stabilize the inner structure of the particles and reduce the degradation of the inner structure of the particles which may occur when the battery is charged and discharged. In addition to tantalum, niobium and vanadium may also be used as an element belonging to Group 5 of the periodic table. Among these elements, tantalum is preferable because tantalum is capable of stabilizing the inner structure of the particles at a higher level.

The total content of the above elements in the positive electrode active material particles is preferably about 0.01% to 7% by mass and is more preferably 0.05% to 2% by mass. If the total content of the above elements is less than 0.01% by mass, it is not possible to improve the characteristics of the battery to a sufficient degree. If the total content of the above elements exceeds 7% by mass, a reduction in the initial capacity of the battery per mass is increased.

### (Others)

Examples of a rare earth element contained in the rare earth compound include scandium, yttrium, lanthanum, cerium, praseodymium, neodymium, samarium, europium, gadolinium, terbium, dysprosium, holmium, erbium, thulium, ytterbium, and lutetium. In particular, neodymium, samarium, and erbium are preferable because compounds containing neodymium, samarium, or erbium have a smaller average particle diameter and are likely to precipitate so as to disperse on the surfaces of the lithium transition metal oxide particles in a more uniform manner than other rare earth compounds.

Specific examples of the rare earth compound include hydroxides and oxyhydroxides such as neodymium hydroxide, neodymium oxyhydroxide, samarium hydroxide, samarium oxyhydroxide, erbium hydroxide, and erbium oxyhydroxide; phosphoric acid compounds and carbonic acid compounds such as neodymium phosphate, samarium phosphate, erbium phosphate, neodymium carbonate, samarium carbonate, and erbium carbonate; and neodymium oxide, samarium oxide, and erbium oxide. In particular, hydroxides and oxyhydroxides of a rare earth element are preferable because they are capable of being dispersed in a more uniform manner and do not reduce the output of the battery even when the battery is normally charged and discharged at various temperatures with various voltages.

The average particle diameter of the rare earth compound is preferably 1 nm or more and 100 nm or less and is further preferably 10 nm or more and 50 nm or less. If the average particle diameter of the rare earth compound exceeds 100 nm, the diameter of rare earth compound particles is increased and the number of rare earth compound particles is accordingly reduced. As a result, the reduction in the decomposition of the electrolyte solution may be limited.

On the other hand, if the average particle diameter of the rare earth compound is less than 1 nm, the surfaces of the lithium transition metal oxide particles are closely covered with the rare earth compound and, as a result, the ability of the surfaces of the lithium transition metal oxide particles to occlude and release lithium ions may be degraded. This deteriorates the charge-discharge characteristics of the battery.

For depositing a compound containing the above-described element on the surfaces of the positive electrode active material particles, for example, the following methods may be employed: a method in which a solution in which lithium-nickel-cobalt-manganese composite oxide particles are dispersed is mixed with an aqueous solution of at least one salt selected from the above-described group; and a method in which the aqueous solution is sprayed on lithium-nickel-cobalt-manganese composite oxide particles.

A solution of a rare earth element and or like may also be prepared by dissolving an oxide of the rare earth element in nitric acid, sulfuric acid, acetic acid, or the like, instead of dissolving a sulfuric acid compound, an acetic acid compound, or a nitric acid compound of the rare earth element or the like in water.

The ratio of the mass of the rare earth compound to the total mass of the lithium transition metal oxide is preferably 0.005% by mass or more and 0.5% by mass or less and is more preferably 0.05% by mass or more and 0.3% by mass or less in terms of rare earth element. If the ratio is less than 0.005% by mass, the advantageous effect of the compound containing a rare earth element may be degraded. If the ratio is 0.5% by mass or more, the surfaces of the lithium transition metal oxide particles may be covered with the rare earth compound in an excessive manner and, as a result, the initial normal-temperature output of the battery may be degraded.

An example of the positive electrode active material is a lithium transition metal composite oxide. In particular, a Ni—Co—Mn-based lithium composite oxide and a Ni—Co—Al-based lithium composite oxide are preferable because they have a high capacity and high input-output characteristics. Other examples of the positive electrode active material include lithium-cobalt composite oxides, Ni—Mn—Al-based lithium composite oxides, and olivine-type transition metal oxides containing iron, manganese, and the like (represented by LiMPO₄, where M represent an element selected from Fe, Kn, Co, and Ni). The above positive electrode active materials may be used alone or in combination.

Ni—Co—Mn-based lithium composite oxides having a publicly known composition, such as Ni—Co—Mn-based lithium composite oxides in which the molar ratio of Ni, Co, and Mn is 1:1:1, 5:2:3, or 4:4:2, may be used. In particular, in order to increase the capacity of the positive electrode, a Ni—Co—Mn-based lithium composite oxide in which the contents of Ni and Co are higher than the Mn content is preferably used. Specifically, the ratio of the difference in molar ratio between Ni and Mn to the total number of moles of Ni, Co, and Mn is preferably 0.04% or more. Regardless of whether only a single type of positive electrode active material is used or different types of positive electrode active materials are used, the diameter of particles of the positive electrode active materials may be the same as or different from one another.

The lithium transition metal oxide may further contain additional elements. Examples of the additional elements include boron, magnesium, aluminium, titanium, chromium, iron, copper, zinc, molybdenum, zirconium, tin, tungsten, sodium, potassium, barium, strontium, and calcium.

The nonaqueous electrolyte solution used for producing the nonaqueous electrolyte secondary battery including the positive electrode active material for nonaqueous electrolyte secondary batteries according to the present invention may contain cyclic: carbonates such as ethylene carbonate, propylene carbonate, butylene carbonate, and vinylene carbonate and linear carbonates such as dimethyl carbonate, methyl ethyl carbonate, and diethyl carbonate, which have been used in the related art. In particular, a mixed solvent including a cyclic carbonate and a linear carbonate is preferably used because it is a nonaqueous solvent having a low viscosity, a low-melting point, and a high lithium-ion conductivity. The volume ratio between the cyclic carbonate and the linear carbonate included in the mixed solvent is preferably limited to be 2:8 to 5:5. The above solvents may be used in combination with a compound containing an ester, such as methyl acetate, ethyl acetate, propyl acetate, methyl propionate, ethyl propionate, or γ-butyrolactone. The above solvents may also be used in combination with a compound containing a sulfone group, such as propane sultone; or a compound containing an ether, such as 1,2-dimethoxyethane, 1,2-diethoxyethane, tetrahydrofuran, 1,3-dioxane, 1,4-dioxane, or 2-methyltetrahydrofuran. The above solvents may also be used in combination with a compound containing a nitrile, such as butyronitrile, valeronitrile, n-heptanenitrile, succinonitrile, glutaronitrile, adiponitrile, pimelonitrile, 1,2,3-propanetricarbonitrile, or 1,3,5-pentanetricarbonitrile; or a compound containing an amide, such as dimethylformamide. In the above solvents, some hydrogen atoms H may be replaced with a fluorine atom F.

Examples of a lithium salt that can be used for producing the nonaqueous electrolyte secondary battery including the positive electrode active material for nonaqueous electrolyte secondary batteries according to the present invention include fluorine-containing lithium salts that have been used in the related art, such as LiPF₆, LiBF₄, LiCF₃SO₃, LiN(FSO₂)₂, LiN(CF₃SO₂)₂, LiN(C₂F₅SO₂)₂, LiN(CF₃SO₂) (C₄F₉SO₂), LiC(C₂F₅SO₂)₃, and LiAsF₆. Optionally, a mixture of the fluorine-containing lithium salt with a lithium salt [lithium salt containing one or more elements selected from P, B, O, S, N, and Cl (e.g., LiClO₄)] other than fluorine-containing lithium salts may also be used. In particular, a mixture of a fluorine-containing lithium salt and a lithium salt containing an oxalato complex as an anion is preferable in order to form a stable coating film on the surface of the negative electrode even in a high-temperature environment.

Examples of the lithium salt containing an oxalato complex as an anion include LiBOB [lithium-bisoxalatoborate], Li[B(C₂O₄)F₂], Li[P(C₂O₄)F₄], and Li[P(C₂O₄)₂F₂]. Among the above lithium salts, LiBOB is preferably used in order to form a particularly stable coating film on the surface of the negative electrode.

Examples of a separator that can be used for producing the nonaqueous electrolyte secondary battery according to the present invention include separators composed of polypropylene or polyethylene, polypropylene-polyethylene multilayer separators, and separators coated with an aramid resin or the like, which have been used in the related art.

Negative electrode active materials that have been used in the related art may be used as a negative electrode active material for producing the negative electrode of the nonaqueous electrolyte secondary battery according to the present invention. Specific examples of the negative electrode active materials include carbon materials capable of occluding and releasing lithium, metals capable of being alloyed with lithium, and alloy compounds containing such metals. Examples of the carbon materials include graphite such as natural graphite, nongraphitizable carbon, and artificial graphite and coke. Examples of the alloy compounds include compounds including at least one metal capable of being alloyed with lithium. In particular, the element capable of being alloyed with lithium is preferably silicon or tin. For example, alloys containing silicon or tin may also be used. Optionally, another carbon material (e.g., amorphous carbon or low-crystallinity carbon) may be dispersed or applied on the surfaces of the particles of the above carbon material or alloy compound. A mixture of the carbon material and a compound containing silicon or tin may also be used. In addition, although the energy density of the battery is reduced, materials having a higher potential with respect to a metal lithium such as lithium titanate when the battery is charged and discharged than a carbon material or the like may also be used as a material of the negative electrode.

In addition to silicon and alloys of silicon, silicon oxide (SiOₓ (0<x<2, in particular, 0<x<1 is preferable)) may be used as a negative electrode active material. Thus, silicon also includes silicon contained in a silicon oxide represented by SiOₓ (0<x<2) (SiOₓ=(Si)_{1-1/2x}+(SiO₂)_{1/2x}). It is preferable to mainly use a carbon material as a negative electrode active material. It is particularly preferable to mainly use graphite as a negative electrode active material. Using the above negative electrode active material in combination with the lithium transition metal composite oxide that serves as a positive electrode active material in the present invention makes it possible to maintain the output regeneration characteristics of the battery within a wide range of the depth of charging-discharging capacity.

The negative electrode mixture layer including the negative electrode active material may include, for example, publicly known carbon conductant agents such as graphite and publicly known binders such as CMC (sodium carboxymethyl cellulose) and SBR (styrene-butadiene rubber).

A layer composed of an inorganic filler, which has been used in the related art, may be formed at the interface between the positive electrode and the separator or the interface between the negative electrode and the separator. The filler may be an oxide or phosphoric acid compound containing one or more elements selected from titanium, aluminium, silicon, magnesium, and the like, which has been used in the related art. The surfaces of the filler-particles may optionally be treated with a hydroxide or the like. The filler layer can be formed by, for example, directly applying a slurry containing the filler to the positive electrode, the negative electrode, or the separator or by bonding a sheet composed of the filler to the positive electrode, the negative electrode, or the separator.

### INDUSTRIAL APPLICABILITY

The nonaqueous electrolyte secondary battery according to an embodiment of the present invention can be used as a power source for driving an electric vehicle (EV), a hybrid electric vehicle (HEV, PHEV), or an electric tool which particularly requires a power source having a long service life. It is expected that the nonaqueous electrolyte secondary battery will be included in mobile Information terminals such as mobile telephones, notebook computers, smart phones, and tablet terminals.

1. A positive electrode active material for nonaqueous electrolyte, secondary batteries, the positive electrode active material comprising a lithium transition metal oxide including at least one element selected from the group consisting of elements belonging to Group 5 of the periodic table, the lithium transition metal oxide including a rare earth compound deposited on a surface of the lithium transition metal oxide.

2. The positive electrode active material for nonaqueous electrolyte secondary batteries according to claim 1, wherein the element belonging to Group 5 of the periodic table is included inside a particle of the lithium transition metal oxide.

3. The positive electrode active material for nonaqueous electrolyte secondary batteries according to claim 1, wherein the element belonging to Group 5 of the periodic table is included in a crystal of the lithium transition metal oxide.

4. The positive electrode active material for nonaqueous electrolyte secondary batteries according to anyone of claim 1, wherein the element belonging to Group 5 of the periodic table is tantalum.

5. The positive electrode active material for nonaqueous electrolyte secondary batteries according to claim 1, wherein the rare earth compound is at least one compound selected from a hydroxide, an oxide, an oxyhydroxide, a carbonic acid compound, a phosphoric acid compound, and a fluorine compound.

6. The positive electrode active material for nonaqueous electrolyte secondary batteries according to anyone of claim 1, wherein the rare earth compound is a hydroxide or an oxyhydroxide.

7. A nonaqueous electrolyte secondary battery comprising the positive electrode active material for nonaqueous electrolyte secondary batteries according to claim 1.

8. The positive electrode active material for nonaqueous electrolyte secondary batteries according to claim 2, wherein the element belonging to Group 5 of the periodic table is tantalum.

9. The positive electrode active material for nonaqueous electrolyte secondary batteries according to claim 3, wherein the element belonging to Group 5 of the periodic table is tantalum.
